(19) United States
(12) Patent Application Publication
(10) Pub. No.: US 2007/0103155 A1
(43) Pub. Date: May 10, 2007

(54) Method and apparatus for magnetic resonance imaging using directional selective K-space acquisition

(76) Inventors: Nikolaos V. Tsekos, St. Louis, MO (US); Dawei Gui, Sussex, WI (US)

Correspondence Address: THOMPSON COBURN, LLP, ONE US BANK PLAZA, SUITE 3500, ST LOUIS, MO, 63101, US

(21) Appl. No.: 11/271,119

(22) Filed: Nov. 10, 2005

(51) Int. Cl. G01V 3/00

(52) U.S. Cl. 324/307

(57) ABSTRACT

A method of selecting a portion of k-space data for acquisition in a magnetic resonance imaging (MRI) scan of a body, the body having a target therein. The method includes defining the target in real space, translating the defined target into a k-space representation thereof and selecting the region corresponding to the k-space representation of the target for data acquisition during the MRI scan, wherein the MRI scan is substantially limited to acquisition of the selected region. In addition, this method may include the target having an orientation relative to the principal axis of the MRI scan and the target defining step includes defining the target in terms of target length “L_{R}”, target width “W_{R}”, and target angular orientation “θ_{R}” relative to the MRI scan principal axis and the translating step may include converting L_{R}, W_{R}, and θ_{R} to their k-space representations L_{K}, W_{K}, and θ_{K}.

### TECHNICAL FIELD OF THE INVENTION

The present invention relates to medical imaging, particularly an improved technique for fast gathering of magnetic resonance imaging (MRI) data suitable, by way of example, for facilitating interventional MRI processes and the like.

### BACKGROUND OF THE INVENTION

When a patient undergoes an MRI scan, the original data generated by the MRI scanner belongs to a mathematical region known as inverted space or k-space (thereby creating k-space data or “raw data”). The k-space data undergoes a fast Fourier transformation (FFT) to generate the real space MRI image, as is well-known in the art. The k-space data has specific patterns of signal intensity that are characteristic of the magnetic resonance pertinent features of the anatomical structures inside imaged section or part of the body. In general, to accurately image the real-space anatomies, collection of a large amount of data in the k-space is required. As a result, data acquisition is long; as an example, it may take from about 400 ms per slice to minutes per data set. This can be a time-consuming process that hinders the use of MRI in an interventional manner, particularly in fields such as neurosurgery, cardiac surgery, vascular interventions and the like.

Because of the sheer quantity of data in the k-space data set, the time it takes to acquire a full k-space data set is also a hindrance because the time needed to complete a scan is relatively lengthy. For example, patient motion needs to be kept to a minimum during a patient scan. An example of patient motion that can hinder the quality of an MR image is a patient's breathing. Often the patient is instructed to hold his/her breath while the MRI scan is taken. However, for injured, sick, and elderly patients (especially those with cardiac conditions), compliance with such instructions is not practical.

### SUMMARY OF THE INVENTION

There is a need in the art for the ability to quickly acquire k-space data while maintaining high image quality. Toward this end, the inventors herein have developed a technique termed Directional Selective K-space Acquisition (DISKA). Through DISKA, a correlation between the geometry of a target and that target's k-space representation is utilized to acquire a selected portion of the k-space data rather than the full k-space data, thereby reducing acquisition time. Generally, the present invention provides a method for selecting a portion of k-space data for acquisition in a magnetic resonance imaging (MRI) scan of a body, the body having a target therein, the method comprising: (1) defining the target in real space; (2) translating the defined target into a k-space representation thereof; and (3) selecting the region corresponding to the k-space representation of the target for data acquisition during the MRI scan, wherein the MRI scan is substantially limited to acquisition of the selected region.

Preferably, the target is parametrically defined in real space using parameters such as length L_{R}, width W_{R}, and angular orientation θ_{R}. For targets having a curved shape (for example, vessels such as arteries), the parameter L_{R} would represent the arc length of the curved vessel and an additional parameter—curvature angle φ_{R}—is preferably used to define the target in real space. Curved shapes such as arcs (which are useful in modeling the geometry of a blood vessel) generally exhibit a bow tie shape in k-space coordinates. The bow tie shape can be represented in k-space with the parameters bow tie length L_{K} (which is a function of 1/W_{R}), bow tie central width W_{K} (which is a function of 1/L_{R}), bow tie angular orientation θ_{K} (which is a function of θ_{R}), and bow tie radial angular expansion φ_{K} (which is a function of φ_{R}).

Data acquisition can be limited to the k-space region corresponding to target's k-space parameters. Because the data points with the highest signal intensity (or power) pertinent to the target of interest are concentrated in this k-space region, the resulting image retains high quality despite the collection of fewer data points.

Additionally, DISKA may be used to image more complex target geometries such as vessel branches. The vessel branch may be broken down into a plurality of discrete segments with each segment's geometric parameters being converted to a corresponding representation in k-space. The k-space representations of each segment can be superimposed over each other to create a super region in k-space that is selected for data acquisition.

Further, to improve image quality, a greater number of data points near the center of k-space may be selected for acquisition. Because most of the data points corresponding to the target with the highest signal intensity will be concentrated in the central area of the k-space, it is advantageous to select a centralized region of the k-space for acquisition in addition to any k-space region that corresponds to the target geometry.

Also, it is envisioned that an alternative embodiment may be used to implement DISKA wherein a plurality of predefined k-space regions are stored in a database and compared to a given target geometry to find which predefined k-space region most closely corresponds to the target. Accordingly, also disclosed herein is a method of selecting a portion of k-space data for acquisition in a magnetic resonance imaging (MRI) scan of a body, the body having a target therein, the method comprising: (1) defining the target in real space; (2) providing a plurality of pre-defined k-space representations, each corresponding to a different target geometry; (3) determining which pre-defined k-space representation most closely corresponds to the defined target; and (4) selecting the region corresponding to the determined k-space representation for data acquisition during the MRI scan, wherein the MRI scan is substantially limited to acquisition of the selected region.

Lastly, as would be understood by those of ordinary skill in the art, the present invention may be implemented in software, hardware, or some combination thereof.

These and other features and advantages of the present invention will be in part apparent and in part pointed out in the following description, figures, and enclosed appendices.

### BRIEF DESCRIPTION OF THE DRAWINGS

FIG. 1 illustrates a 256×256 array of k-space data;

FIG. 2 illustrates a patient positioned in an MRI scanner relative to a coordinate system;

FIG. 3(a) illustrates a band shape in real space coordinates;

FIG. 3(b) illustrates the k-space translation of the band shape of FIG. 3(a).

FIG. 4(a) illustrates a curve shape in real space coordinates;

FIG. 4(b) illustrates the k-space translation of the curve shape of FIG. 4(a);

FIG. 5 illustrates the steps of the DISKA process;

FIGS. 6(a)-(d) illustrate application of DISKA to a vessel branch;

FIGS. 7(a)-(c) illustrate DISKA wherein a greater number of data points in the central area of the k-space are collected;

FIG. 8 illustrates two simulated curves and their corresponding representations in k-space;

FIG. 9 illustrates signal profiles in k-space;

FIG. 10 illustrates the first lobe profiles where Q (also referred to as φ_{R}) equals 15° and 45°;

FIG. 11 illustrates simulation results under four analyses;

FIG. 12 illustrates simulation results for selectively targeting four imaging branches of a virtual vessel using DISKA 25% k-space acquisition;

FIG. 13 illustrates experimental results from a phantom with vessel-mimicking tubing network using DISKA with 34% k-space acquisition;

FIG. 14 illustrates representative images of a test patient's right coronary artery using three different techniques, including DISKA;

FIG. 15 illustrates a quality comparison between the three different techniques of FIG. 14; and

FIG. 16 illustrates an alternative embodiment wherein a plurality of pre-defined k-space regions are processed to determine which one most closely corresponds to the target geometry.

### DETAILED DESCRIPTION OF THE PREFERRED EMBODIMENT

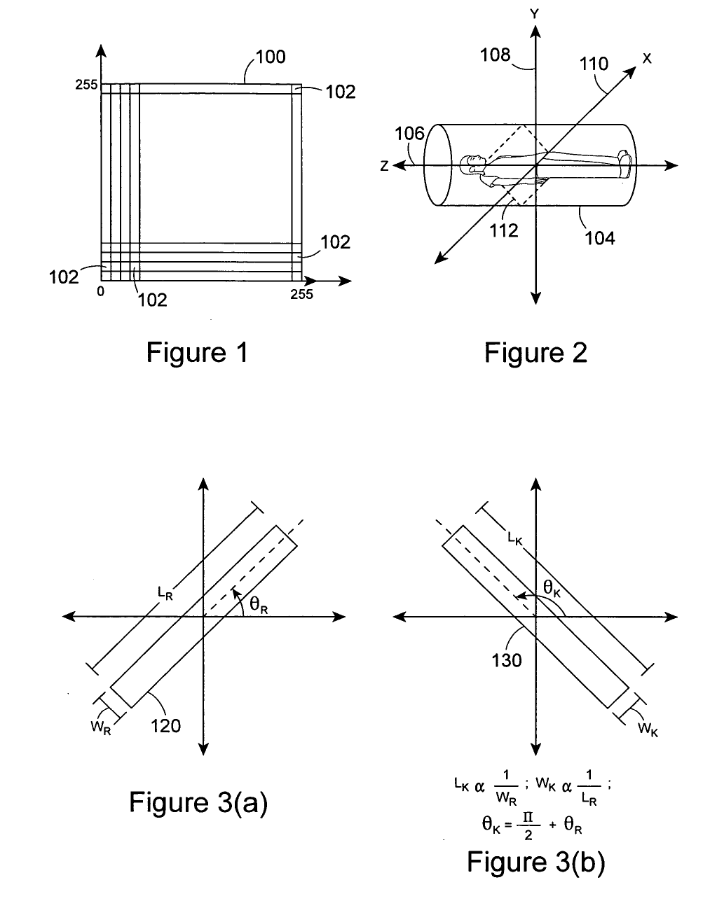

With reference to FIG. 1, and as is well-known in the art, the raw data produced by an MRI scan belong to a frequency space, known as k-space data (or raw data) and converted to the real-space image by way of a fast Fourier transform (FFT). The k-space data is expressed as m×m arrays such as the 256×256 array 100 with 65,536 data points 102, as shown in FIG. 1.

Under conventional techniques, the full 256×256 k-space data set is acquired, and the MR image is derived therefrom. However, as previously mentioned, it would be advantageous for MR systems to increase speed by acquiring only that portion of the k-space necessary to derive a quality image of the target of interest.

Toward this end, the inventors herein utilize correlations between target geometries in real space and their corresponding k-space representations. Once the basic geometry of the target in real space is known, the present invention determines the region of k-space that corresponds to such geometry. Having determined the k-space region for which data points 102 are needed, a selective acquisition of k-space data points can be implemented without sacrificing image quality because the data points important to the target are collected while collection of background (insubstantial) data points is avoided. This improved technique is termed DIrectional Selective k-space Acquisition (DISKA).

The first step of DISKA involves defining the target. Examples of suitable targets for DISKA include blood vessels and other body lumens. However, as would be understood by one of ordinary skill in the art, any internal body part capable of geometric modeling in real space can be used in the practice of the present invention. With reference to FIG. 2, for a given target within a patient's body, the target's orientation relative to the principal axis (z-axis 106 of a coordinate system with an x-axis 100, y-axis 108, and z-axis 106) of the scanner 104 should be known. This information is standard to the practice of MRI imaging. Additionally, the curvature of the target should be known. To gather such details of target geometry, the inventors envision a number of suitable techniques. For example, a scout image of the target region can be generated (such as a 2D slice, 2D multislice, 3D image, and the like) and analyzed to learn the target's basic geometry. Software shape recognition algorithms (both interactive and automated) may be used to determine target geometry from the scout image. Additionally, a physician, MR scanner operator, physician technician, or any person trained in the art of medical imaging may independently analyze the scout image and input the target geometry into the DISKA system.

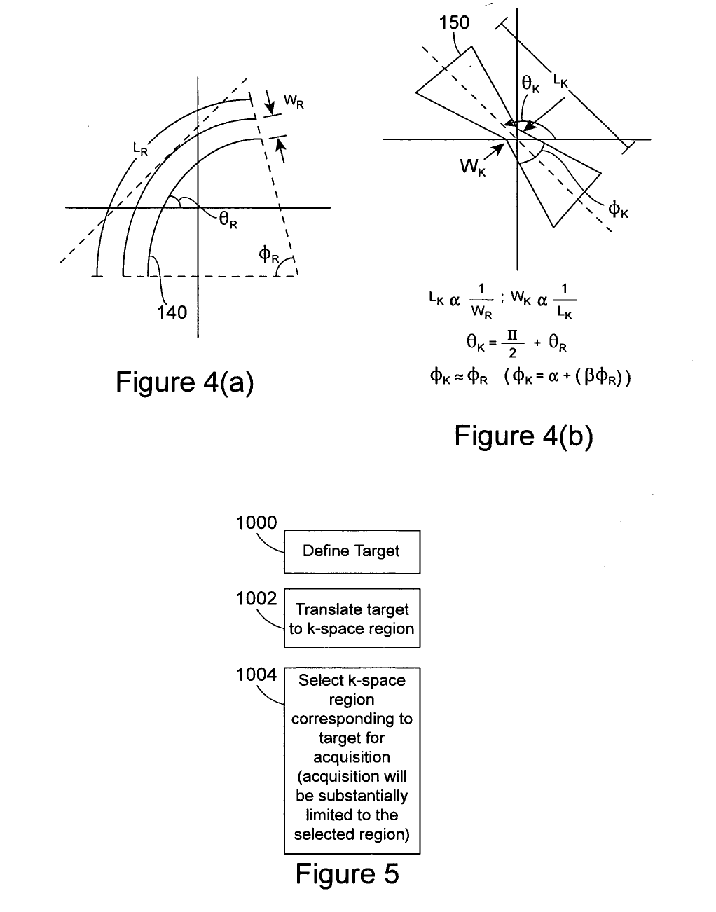

Two suitable examples of target geometries for DISKA are substantially straight “band” targets such as band 120 shown in FIG. 3(a) and curved targets such as arc 140 shown in FIG. 4(a). A band shape in real space translates to an orthogonal band shape in k-space wherein the geometry of the band in k-space is related to the geometry of the band in real space. An arc or curve in real space translates to a bow tie shape in k-space wherein the geometry of the bow tie shape in k-space is related to the geometry of the arc in real space. Therefore, once knowledge is gained of the geometry of the target in real space (its basic shape dimensions and orientation relative to the scanning axis), one can predict the pertinent region in k-space where substantially important signals corresponding to the target are located. Thereafter, data acquisition can be limited to that pertinent k-space region, which greatly improves image acquisition times without sacrificing image quality (because the important signal corresponding to the desired image is present in the k-space region that is actually acquired).

With reference to FIG. 3(a), which depicts a target band 120 in real space, preferable target geometry parameters for band 120 are band length L_{R}, band width W_{R}, and band angular orientation θ_{R}. These parameters suitably define the target in real space.

FIG. 3(b) depicts a representation 130 of target 120 in k-space. The pertinent parameters for defining representation 130 in terms of k-space are band length L_{K} band width W_{K}, and band angular orientation θ_{K}. Band length L_{K} is a function of 1/W_{R}, band width W_{K} is a function of 1/L_{R}, and band angular orientation θ_{K} is equal to (π−θ_{R}). Thus, the greater the width of the band in real space, the shorter its length in k-space. Similarly, the greater the length of the band in real space, the narrower its width in k-space. The angular orientation of the two bands is orthogonal. Also, it is worth noting, that the band in real space can be at any off-center location (as example centered at an X_{O}, Y_{O} coordinate). Its Fourier pair in k-space has a magnitude component which is always substantially centered at the origin of the k-space coordinate systems.

With reference to FIG. 4(a), which depicts a target curve 140 in real space, preferable target parameters for curve 140 are curve arc length L_{R}, curve width W_{R}, curve angular orientation θ_{R} (defined by the intersection of the curve's tangent and the horizontal axis), and curvature angle φ_{R}. These parameters suitably define the target in real space.

FIG. 4(b) depicts a representation 150 of target 140 in k-space. As can be seen, the curve's representation in k-space has a bow tie shape having a central region around the origin of a certain width and radial extensions that expand outward therefrom at an angle. As shown in FIG. 4(b), the pertinent parameters for defining representation 150 in terms of k-space are bow tie length L_{K}, bow tie width W_{K} (which represents the width of the central area of the bow tie), bow tie angular orientation θ_{K}, and bow tie expansion angle φ_{K}. Bow tie length L_{K} is a function of 1/W_{R}, bow tie width W_{K} is a function of 1/L_{R}, bow tie angular orientation θ_{K} is equal to (π/2+θ_{R}), and bow tie expansion angle φ_{K} is substantially equal to φ_{R}. Preferably, expansion angle φ_{K} is set equal to α+(β*φ_{R}) wherein α and β are parameters chosen to reduce artifacts and increase the available signal, whose values can be determined analytically, experimentally or empirically as would be within the skill of an ordinary artisan following the teachings of the present invention. Also, it should be noted that the angles described above and depicted in the figures may be changed to different angles so long as they describe the orientation of the structure or a tangent at a well-defined point of the structure. For example, the center of the arc may be used with the pertinent angle being the angle between an imaginary line extending from the origin to the arc center and a frame of reference such as an axis or the arc tangent. Therefore, for curves of varying geometries (greater/lesser arc length, greater/lesser width, greater/lesser angular orientation, and/or greater/lesser curvature), the geometry of the k-space bow tie shape will be predictably altered. For example, for real space curves with greater curvature, the bow tie expansion angle φ will be greater, thereby giving the bow tie a wider expansion at its ends. For relatively thick curves in real-space, the bow tie length in k-space will become relatively shorter. The angular orientation of the curve in real space will affect the bow tie's angular orientation (they will be orthogonal to each other). As with the band shape of FIGS. 3(a) and 3(b), it is worth noting, that the curved band in real-space can be at any off-center position relative to the origin of the real-space, and the bow tie magnitude component is substantially centered at the origin of the k-space coordinate systems.

In predicting the k-space parameters for a given real space shape, the formula below may be used:

$${Dimension}_{k - space} = \frac{A}{γ {\int }_{0}^{Δ t} G ( t ) ⅆ t \cdot {Dimension}_{real - space}}$$

wherein A represents acquisition parameters relating to the set-up of the particular scanner being used, the scanner gradient performance, and other acquisition parameters, as is well known in the art, wherein γ represents the gyromagnetic ratio, wherein G(t) represents the magnetic field gradient that is used to encode spatial localization, and wherein Δt represents the duration of the gradient application. Thus, as to the dimensions L_{K} and W_{K}, and remembering that L_{K} is related to W_{R} and that W_{K} is related to L_{R}, one may use the formulas:

$${L}_{k - space} = \frac{A}{γ {\int }_{0}^{Δ t} G ( t ) ⅆ t \cdot {W}_{real - space}}$$

$${W}_{k - space} = \frac{A}{γ {\int }_{0}^{Δ t} G ( t ) ⅆ t \cdot {L}_{real - space}}$$

Additional details relating to DISKA are disclosed herein in the inventors' papers Gui and Tsekos, Structure-Targeting Fast Magnetic Resonance Imaging Angiography with Partial Collection of the Inverse Space (k-Space) based on the Orientation of the Vessel in Real Space, and Gui and Tsekos, DISKA: Directional Selective k-space Acquisition for Dynamic MR Angiography of Contrast Enhanced Blood Vessels, which are incorporated by reference in their entirety.

Once the pertinent k-space parameters for the target are known, data acquisition can be limited to the k-space region defined by those parameters. FIG. 5 illustrates the pertinent steps of this process. At step 1000, the target is defined in real space. This step involves determining pertinent features of the target geometry (in real space) such as length, width, angular orientation, and curvature (if applicable). Thereafter, at step 1002, the k-space region corresponding to the defined target geometry is determined. As noted above, parameters relating to the target in k-space are determinable from the target parameters in real space. Once the pertinent region in k-space is identified in step 1002, that k-space region can be selected for data acquisition. The scanner can be configured to substantially limit data acquisition to the selected k-space region. For an understanding of how a scanner can be used to limit data acquisition to particular regions, one may refer to the articles Pipe, James G., Motion Correction With PROPELLER MRI: Application to Head Motion and Free-Breathing Cardiac Imaging, Magnetic Resonance in Medicine, vol. 42, pp. 963-969 (1999); and Pipe et al., Multishot Diffusion-Weighted FSE Using PROPELLER MRI, Magnetic Resonance in Medicine, vol. 47, pp. 42-52 (2002), the disclosures of both of which are incorporated herein by reference. Additionally, it is envisioned by the inventors herein that other suitable techniques for controlling a scanner to acquire only user-specified regions of k-space will become available as future developments occur.

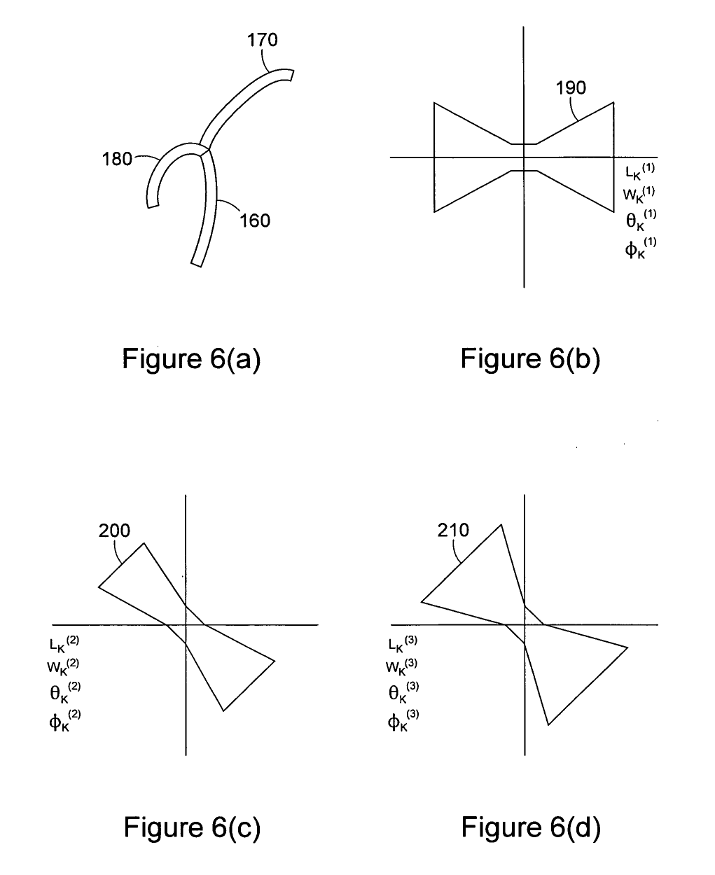

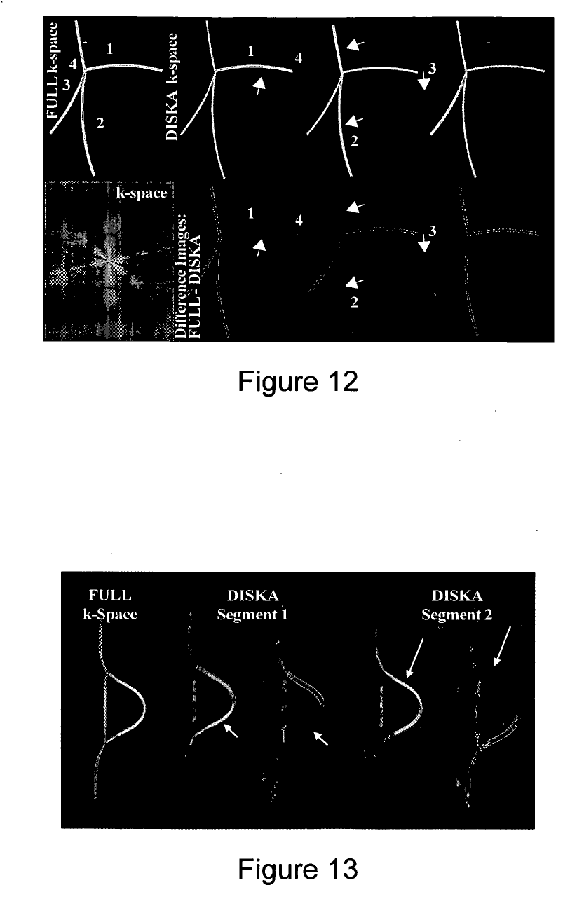

DISKA is also effective for more complex target geometries such as vessel branches. This is based on the fact that the Fourier transform of a structure composed of two or more individual sub-structures is equal to the addition of Fourier Transforms of the individual structures. FIG. 6(a) illustrates an exemplary vessel branch (in real space) defined by three curve shapes 160, 170 and 180. Each curve can be translated to a corresponding k-space region and data acquisition can be limited to the k-space super region defined by the superposition of the three separate k-space regions corresponding to curves 160, 170, and 180. For example, FIG. 6(b) illustrates the k-space bow tie region 190 corresponding to curve 160. The pertinent k-space parameters for region 190 can be defined as L⁽¹⁾_{K}, W⁽¹⁾_{K}, θ⁽¹⁾_{K}, and φ⁽¹⁾_{K}. FIG. 6(c) illustrates the k-space bow tie region 200 corresponding to curve 170. The pertinent k-space parameters for region 200 can be defined as L⁽²⁾_{K}, W⁽²⁾_{K}, θ⁽²⁾_{K}, and φ⁽²⁾_{K}. Lastly, FIG. 6(d) illustrates the k-space bow tie region 210 corresponding to curve 180. The pertinent k-space parameters for region 210 can be defined as L⁽³⁾_{K}, W⁽³⁾_{K}, θ⁽³⁾_{K}, and φ⁽³⁾_{K}. To obtain a quality image of the vessel branch depicted in FIG. 6(a), data acquisition can be limited to the k-space super region defined by the parameters L⁽¹⁾_{K}, W⁽¹⁾_{K}, θ⁽¹⁾_{K}, φ⁽¹⁾_{K}, L⁽²⁾_{K}, W⁽²⁾_{K}, θ⁽²⁾_{K}, φ⁽²⁾_{K}, L⁽³⁾_{K}, W⁽³⁾_{K}, θ⁽³⁾_{K}, and φ⁽³⁾_{K}. While the example of FIGS. 6(a)-(d) illustrate 3 branches, it should be readily understood by those of ordinary skill in the art that more or fewer branches may be used in the practice of the present invention. As an example, this can be the case for imaging selectively a single branch of a vessel to follow a vascular intervention. An example of this is shown in FIG. 12.

It is also worth noting, that most of the signal corresponding to the target is found in the area of the k-space centered around the origin. As such, to improve image quality, it may be desirable to include a large portion of the central area of the k-space in the k-space region selected for acquisition. The shape used for such quality control can be user-defined. Preferable shapes include circles centered around the k-space origin and squares centered around the k-space origin. However, as would be readily understood by those of ordinary skill in the art, other shapes may be used.

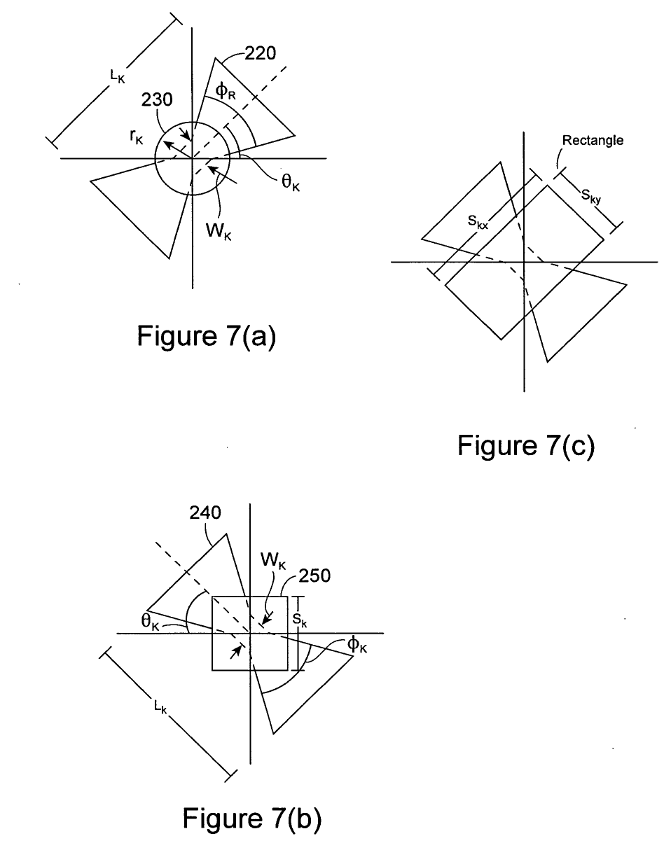

FIG. 7(a) depicts an example wherein the target is a curved vessel defined in k-space by a bow tie shape 220, wherein the bow tie shape 220 is represented by the parameters L_{K}, W_{K}, θ_{K}, φ_{K}. To ensure that an adequate number of data points is collected in the center region of the k-space, where the most important signal is located, the k-space region selection for acquisition may also include a circle 230 that is centered around the origin. The pertinent parameter defining circle 230 is circle radius r_{K}, where r_{K} is proportional to 1/W_{R}. Thus, the superposition of the circle 230 over the bow tie shape 220 represents the region of k-space selected for acquisition. FIG. 7(b) depicts a similar situation wherein a square 250 is superimposed over bow tie shape 240 to ensure adequate data collection. The square (or rectangle as shown in FIG. 7(c)) is also centered around the k-space origin and defined by the parameter side length SK (or S_{KX} by S_{KY} for the rectangular example of FIG. 7(c)).

Simulations of DISKA were performed using software (included herewith as Appendix E) that allows the generation of virtual vessel structures with various curvatures, thickness, spatial direction and lengths. Straight-line (band) vessel segments were studied by varying thickness, length and orientation using analytical solutions with two sinc functions along the length and thickness on a rotated Cartesian system. Curved arc blood vessel segments were studied for various arc segment lengths, thickness and especially stretching angles (Q), using both analytical and numerical solutions. It should be noted that the stretching angle Q is the same as the angle φ_{R}. A matrix of 512×512 was used to visualize the periodicities in the k-space. Data analysis included generation of signal profiles (e.g. FIG. 9) in k- and real-space to identify the significance and the effect of inclusion or not of k-space points on the Gibbs artifacts, vessel sharpness and lumen width. The width was calculated as the full width at half maximum (FWHM) and sharpness as the distance between the 80% and 20% signal reduction along the profile as described in Li et al., Coronary arteries: magnetization-prepared contrast-enhanced three-dimensional volume-targeted breath-hold MR angiography, Radiology, vol. 219, p. 270 (2001) (the disclosure of which is incorporated by reference herein).

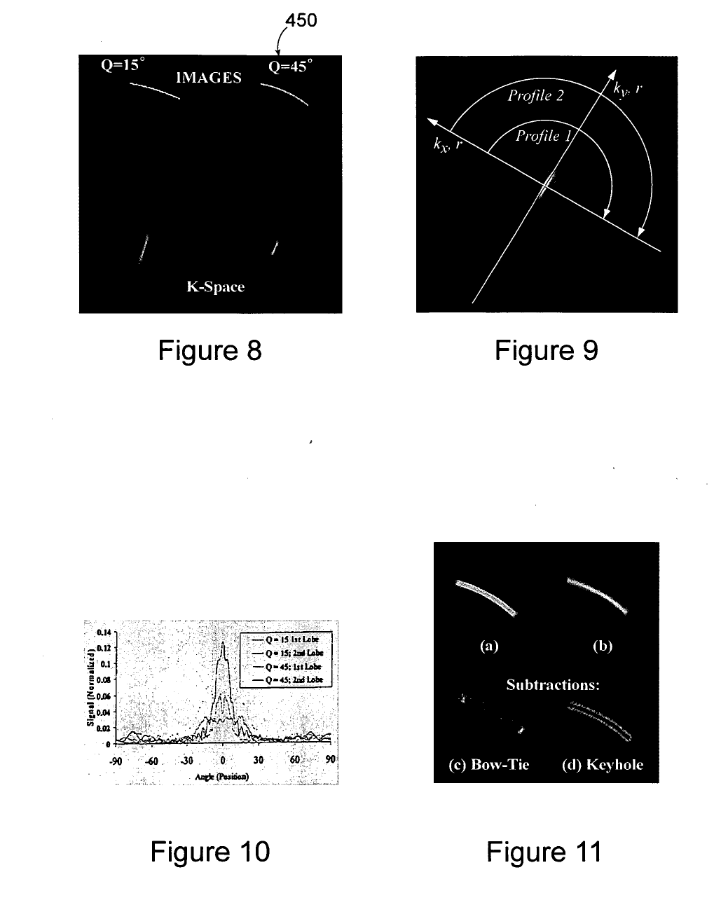

FIG. 8 shows representative results from arched vessel segments, depicting the real image and the k-space for stretching angles of Q=15° and 45°. As expected, most of the signal is at the central k-space area but also extends to higher k-space areas in a “bow-tie” pattern (see FIG. 9). The orientation of the symmetry axis of this pattern (k_{X,R} and k_{Y,R}) is determined by the orientation of the vessel in real-space relative to the real space coordinate system (i.e. gradients). The angle of the signal spread in k-space is related to the stretching angle of the vessel segment in real space; the higher the Q, the wider the opening of the “bow tie” in k-space (FIG. 8). To evaluate that, k-space profiles along semicircles were taken (FIG. 9) and plotted vs. the angular position relative to k_{Y,R}. FIG. 10 shows the 1^{st} lobe profiles for Q=15° and 45°. FIG. 11 shows images generated using (a) the full k-space and (b) the “bow-tie”-like portion of the k-space. To evaluate the extent of artifacts on the reconstructed image, FIG. 11 also shows the (c) subtractions of the full k-space minus the “bow-tie” image (Q=45°; 29% k-space) and (d) full k-space minus a keyhole reconstruction (using 29% of the full k-space). The FWHM for full and “bow-tie” k-space reconstruction were 6.25 and 6.20, and the sharpness 2.0 and 2.0, respectively. Similar results were obtained for the simpler case of straight vessel segments (not shown).

Additional testing of DISKA with computer simulations have been performed. Vessel structures of various curvatures and orientations with bifurcations (5122; lumen 3-6 pixels) were generated and images were reconstructed using “bow-tie” parts of the k-space.

FIG. 12 shows the DISKA implementation on computer-simulated vessels with 25% acquisition of the complete k-space. By using the corresponding portions of the k-space, each one of the vessels 1, 2-4 and 3 was targeted. The targeted vessel (indicated by the arrow) is always accurately reconstructed while the rest are blurred (note the residual signal in the subtraction images in FIG. 12 and table data below).

After the computer simulation studies, the technique was tested on phantoms with vessel-mimicking tubing networks. MRI studies were performed on a 3T Allegra (Siemens) on Gd-filled vessel phantoms using a GRE (TR/TE/α=100/4 ms/90°; FOV 210² mm²; 256×256; slice 7 mm). Data analysis included signal profiles in k- and real-space, signal power to identify the significance of inclusion or not of k-space points on artifacts, vessel sharpness (distance between the 80% and 20% signal reduction of the profile) and lumen FWHM (full width at half maximum). FIG. 13 shows the DISKA implementation on a vessel phantom using a “bow-tie” k-space partial acquisition of 34% of the complete k-space. The images, the corresponding subtractions with the full k-space and the data in the table below clearly show the accurate reconstruction of the targeted vessel branch (indicated by the arrow).

TABLE

| | Computer Simulations | | | | |
|---|---|---|---|---|---|
| | (FIG. 12) | | | | |
| | | DISKA Vessel | DISKA Vessel | Phantom | |
| | | 1 Targeting | 1 targeting | (FIG. 13) | |
| | FULL | Vessel 1 | Vessel 2 | FULL | DISKA |
| FWHM | 6.5 | 6.5 | 6.7 | 3.75 | 3.7 |
| Sharp- | 0.88 | 0.88 | 2.5 | 2.2 | 2.25 |
| ness | | | | | |

Having demonstrated its effectiveness in phantom studies, DISKA was next applied to selectively image a targeted segment of a contrast enhanced coronary vessel in vivo. The DISKA method was tested on normal volunteers (n=3) on a 1.5T Sonata (Siemens) using a breath-hold segmented 2D GRE sequence (segment TR/TE/α=304/5.3/90°; FOV=280×193 mm²; matrix=256×123; slice thickness=7 mm). A single oblique slice was prescribed to include the proximal, middle and, as much as possible, of the distal portions of the Right Coronary Artery (RCA). Gd contrast agent (Gadodiamide: 0.1 mmol/Kg) was administered at 2 ml/sec for 5 sec with the acquisition and was timed with the passage of the agent from the RCA. The raw data were reconstructed with software that allowed the selection of any portion of the k-space; the data were then zero-filled to 256×256 matrix and Fourier transformed with no further manipulation. The DISKA technique was compared with the full k-space reconstruction as well as to a standard key-hole partial k-space reconstruction (see Suga et al., Keyhole method for high-speed human cardiac cine MR imaging, JMRI 10, p. 778 (1999), the disclosure of which is incorporated herein by reference). Vessel signal intensity (SI) profiles of the proximal and middle parts of the RCA were generated and the full width at half maximum (FWHM) and sharpness (the distance between the 80% and 20% signal reduction along the profile) of the vessel were extracted.

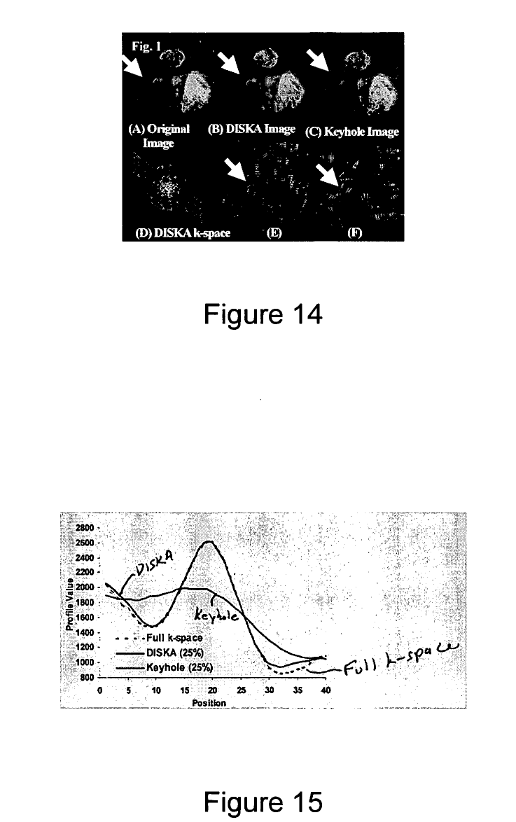

FIG. 14 shows representative images generated with the (A) full k-space, (B) DISKA, targeting the proximal RCA (arrow), and (C) keyhole partial k-spaces. Both the DISKA and keyhole techniques used 25% of the full k-space. FIG. 14 also shows the DISKA partial k-space and the pixel-by-pixel difference of the full k-space with the (E) DISKA image and (F) keyhole image. The images clearly demonstrate that the DISKA reconstruction shows little artifacts on the targeted proximal part of the RCA. While, in the keyhole images, the vessel is distorted and blurred. Similar results are obtained when the middle or distal portion of the RCA was targeted. FIG. 15 shows the profile of the middle part of RCA for the three reconstruction approaches. There is no significant difference between the full k-space and DISKA, while the keyhole shows substantial broadening. The FWHM and the sharpness of the vessel with DISKA reconstruction are less than 10% different from those of the full k-space, while these measured on keyhole reconstruction were 56% and 75% different, respectively. The same results were also obtained from studies without contrast enhancement.

Thus, it can be demonstrated that the present invention represents a substantial improvement in MRI that greatly increases the speed of MR image acquisition. By limiting data acquisition to selected k-space regions of interest, quality images of a target can be obtained in much less time. In simulations, the duration of acquisition (FFT) is reduced by about 75% to about 100 ms, thereby allowing for much faster imaging. This increase in speed, without a significant impact on quality, will permit the use of MRI in an interventional way, such as in neurosurgery, cardiac surgery, etc.

As an alternative to the real space translational technique described above, the present invention may also be implemented by providing a plurality of predefined k-space regions and determining which of these pre-defined k-space regions most closely matches the defined target geometry. Once a closely matching pre-defined k-space region is identified, that k-space region can be selected for acquisition.

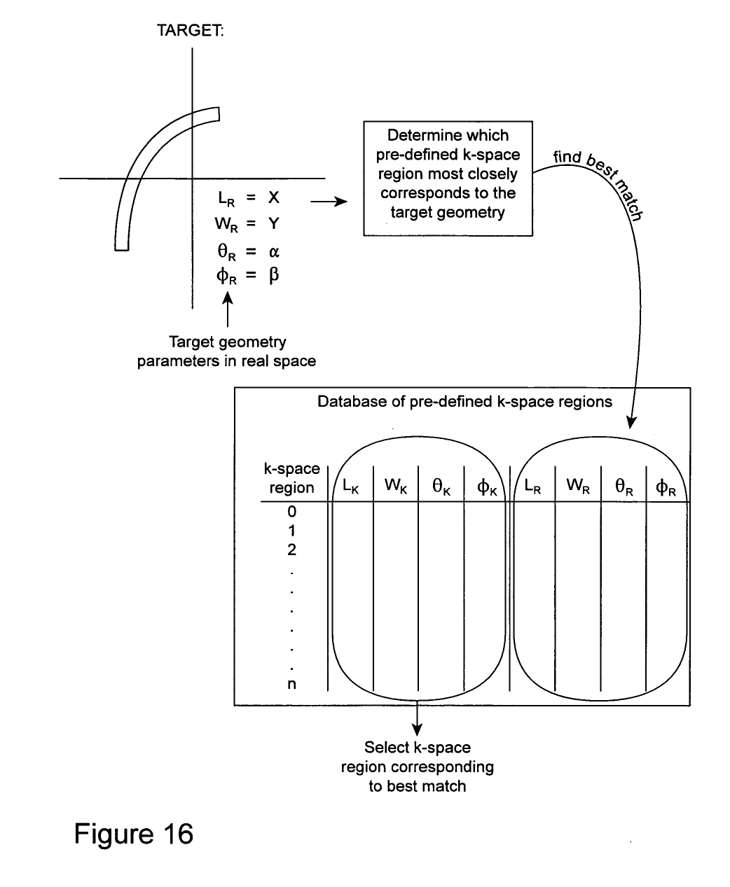

For example, as shown in FIG. 16, a database populated with pre-defined k-space regions, each region defined by the parameters L⁽ⁱ⁾_{K}, W⁽ⁱ⁾_{K}, θ⁽ⁱ⁾_{K}, φ⁽ⁱ⁾_{K} and having corresponding real space parameters L⁽ⁱ⁾_{R}, W⁽ⁱ⁾_{R}, θ⁽ⁱ⁾_{R}, φ⁽ⁱ⁾_{R} can be scanned to determine which k-space region (i) most closely corresponds to the target geometry. Such a determination can be made through comparison of the target geometry parameters and the stored real space parameters corresponding to the different pre-defined k-space regions.

1. A method of selecting a portion of k-space data for acquisition in a magnetic resonance imaging (MRI) scan of a body, the body having a target therein, the method comprising:
defining the target in real space;
translating the defined target into a k-space representation thereof; and
selecting the region corresponding to the k-space representation of the target for data acquisition during the MRI scan, wherein the MRI scan is substantially limited to acquisition of the selected region.

2. The method of claim 1, wherein the target has an orientation relative to the principal axis of the MRI scan, and wherein:
the target defining step comprises defining the target in terms of target length L_{R}, target width W_{R}, and target angular orientation θ_{R} relative to the MRI scan principal axis; and
the translating step comprises converting L_{R}, W_{R}, and θ_{R} to their k-space representations L_{K}, W_{K}, and θ_{K}.

3. The method of claim 2, wherein the target is a curved structure, wherein L_{R} represents the arc length of the curved structure, and wherein:
the defining step further comprises defining the target in terms of curvature angle φ_{R}; and
the translating step further comprises converting φ_{R} to its k-space representation φ_{K} wherein L_{K}, W_{K}, θ_{K}, and φ_{K} together define a substantially bow tie-shaped region in k-space.

4. The method of claim 3, wherein the converting step comprises:
calculating L_{K} according to the formula:
$${L}_{K} = \frac{A}{γ {\int }_{0}^{Δ t} G ( t ) ⅆ t \cdot {W}_{R}}$$
wherein A represents acquisition parameters, wherein γ represents the gyromagnetic ratio, wherein G(t) represents the magnetic field gradient for encoding spatial localization, and wherein Δt represents the duration of the gradient application;
calculating W_{K} according to the formula:
$${W}_{K} = \frac{A}{γ {\int }_{0}^{Δ t} G ( t ) ⅆ t \cdot {L}_{R}} ;$$
calculating θ_{K} according to the formula
θ_{K}=(π/2)+θ_{R}; and
setting φ_{K} equal to α+β*+φ_{R}, where α and β are parameters determined analytically, experimentally or empirically

5. The method of claim 4, wherein the selecting step further comprises selecting an additional k-space region for acquisition having a concentration of data points in a central area of the k-space.

6. The method of claim 3, wherein the target is a vessel branch having a plurality of discrete curved vessels, the method further comprising performing the defining step and translating step for each discrete curved vessel of the vessel branch, and wherein the selecting step comprises selecting each of the regions corresponding to the k-space representations of each curved vessel of the vessel branch.

7. A method of selecting a portion of k-space data for acquisition in a magnetic resonance imaging (MRI) scan of a body, the body having a target therein, the method comprising:
defining the target in real space;
providing a plurality of pre-defined k-space representations, each corresponding to a different target geometry;
determining which pre-defined k-space representation most closely corresponds to the defined target; and
selecting the region corresponding to the determined k-space representation for data acquisition during the MRI scan, wherein the MRI scan is substantially limited to acquisition of the selected region.
